(19) United States
(12) Patent Application Publication
(10) Pub. No.: US 2009/0179562 A1
(43) Pub. Date: Jul. 16, 2009

(54) Lighting group, in particular for exhibition groups, and exhibition groups provided with such lighting group

(75) Inventor: Roberto Tassinari, Padova (IT)

Correspondence Address: HEDMAN & COSTIGAN P.C., 1185 AVENUE OF THE AMERICAS, NEW YORK, NY, 10036, US

(73) Assignee: BESTE S.r.l., Padova (IT)

(21) Appl. No.: 12/152,336

(22) Filed: May 14, 2008

(30) Foreign Application Priority Data
Jan. 10, 2008 (IT) MI2008A 000035

(51) Int. Cl. H01J 1/62

(52) U.S. Cl. 313/506

(57) ABSTRACT

A lighting group (10) comprising a multilayer structure (11), provided with at least one conductive layer (12, 12′, 12″), which lies on specific elastic film, interposed between two insulating layers (13, 13′, 13″, 13′″) and selectively suppliable with current from a related electric conductor (14, 14′, 14″), and at least one lamp element (15, 15′) that can be selectively coupled in any point to the multilayer structure (11) and provided with an upper portion (16) that is luminescent if crossed by current, that is extended outside the multilayer structure (11), and a lower portion (17) that is extended inside the multilayer structure (11), the lower portion (17) comprising at least one electrically conductive zone (18, 18′, 18″) in contact with the at least one conductive transmission layer (12, 12′, 12″) for the current from the at least one conductive layer (12, 12′, 12″) to the upper portion (16).

The present invention refers to a lighting group, in particular for exhibition groups, and an exhibition group provided with such lighting group.

Today there are many different types of lighting groups which are generally but not only associated with exhibition groups in order to light, according to particular needs, the products housed in the aforesaid exhibition groups.

Nevertheless, disadvantageously, such known lighting groups today have the disadvantage of making, once installed on the related exhibition groups, a lighting that cannot be easily modified according to needs.

In other words, it is not possible today to modify the lighting type with which it is intended to put in evidence several exhibited products, without having to employ lengthy operations and/or substitute lighting groups themselves.

With the terms “modify the lighting type” mentioned above, it is intended, for example, to modify the position of the light source points, and therefore the actual lighting, and/or modify the emitted colour.

The object of the present invention is that of making a device capable of resolving the abovementioned drawbacks of the prior art in an extremely simple, economical and particularly functional manner.

Another object is that of making a lighting group capable of modifying the lighting emitted by the group itself without expenses, in a quick manner and by means of simple manual operations.

These objects according to the present invention are achieved by making a lighting group, in particular for exhibition groups, and an exhibition group equipped with such lighting group as set forth in claims 1 and 11, respectively.

Further characteristics of the invention are highlighted by the dependent claims.

The characteristics and advantages of a lighting group, in particular for exhibition groups, and an exhibition group equipped with such lighting group according to the present invention will be more evident from the following exemplifying and non-limiting description, referred to the attached schematic diagrams in which:

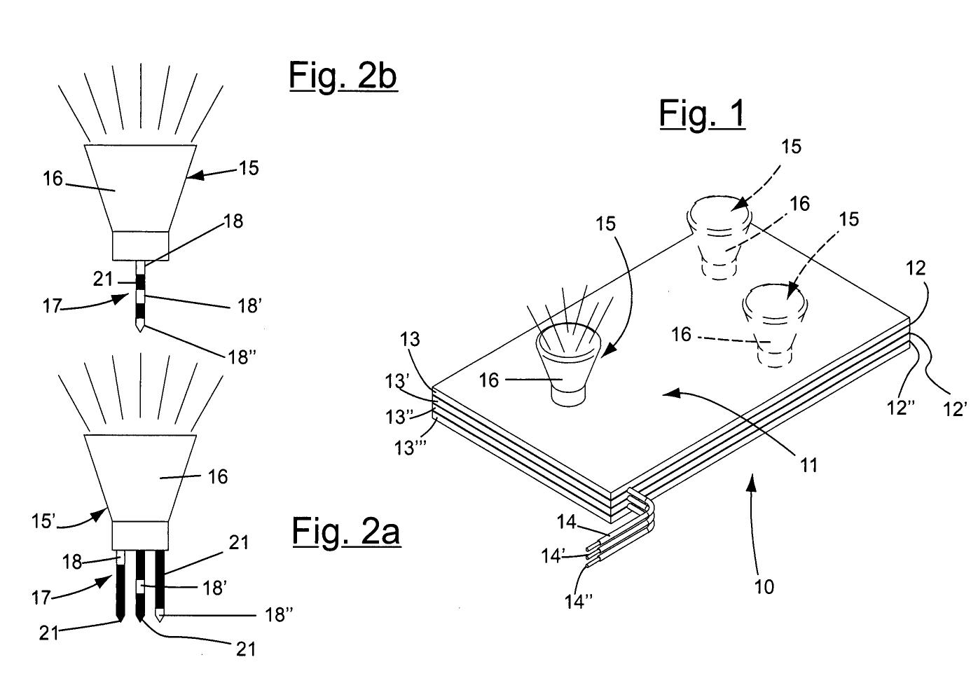

FIG. 1 is a perspective view of an embodiment of a lighting group according to the present invention;

FIG. 2a is an elevation view of a first embodiment of an element of the lighting group according to the present invention;

FIG. 2b is an elevation view of another embodiment of an element of the lighting group according to the present invention;

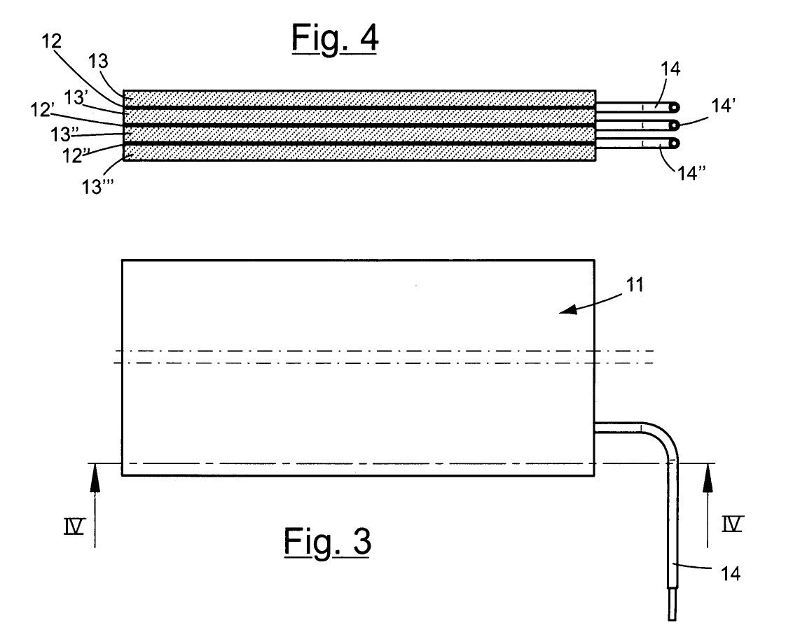

FIG. 3 is a top view of an embodiment of another element of the lighting group according to the present invention;

FIG. 4 is a section view of the element of FIG. 3 along the section line IV-IV;

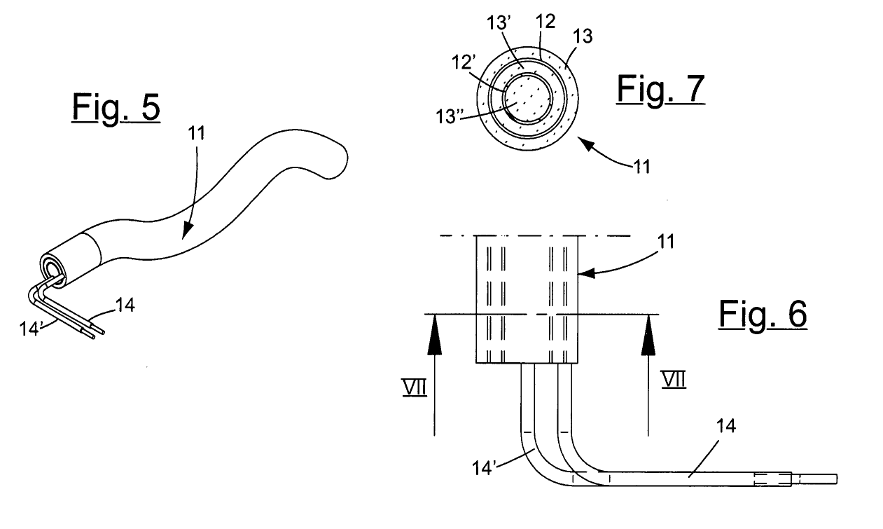

FIG. 5 is a perspective view of another embodiment of an element of the lighting group according to the present invention;

FIG. 6 is a top view of a portion of the element of FIG. 5;

FIG. 7 is a section view of the element of FIG. 6 along the section line VII-VII;

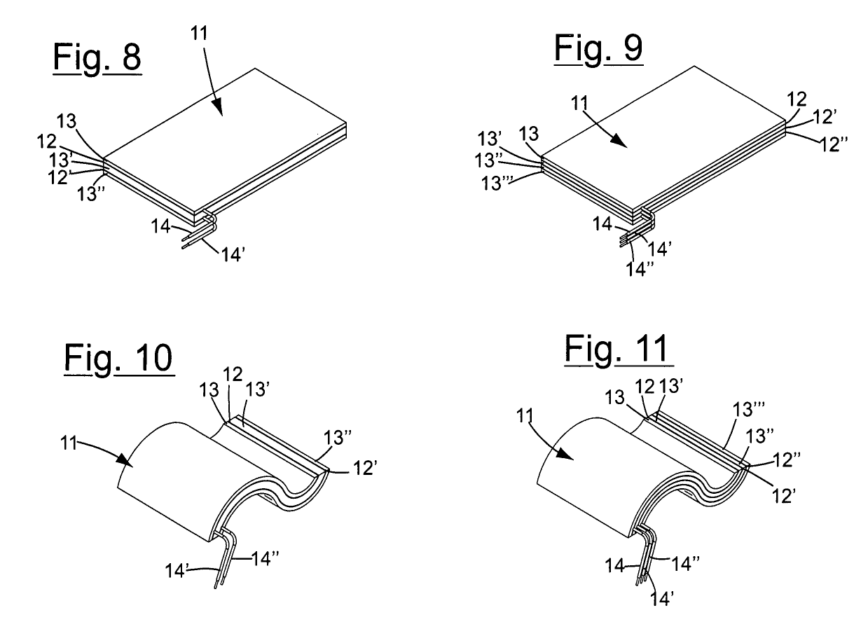

FIGS. 8-11 are perspective views of several embodiments of an element of the lighting group according to the present invention;

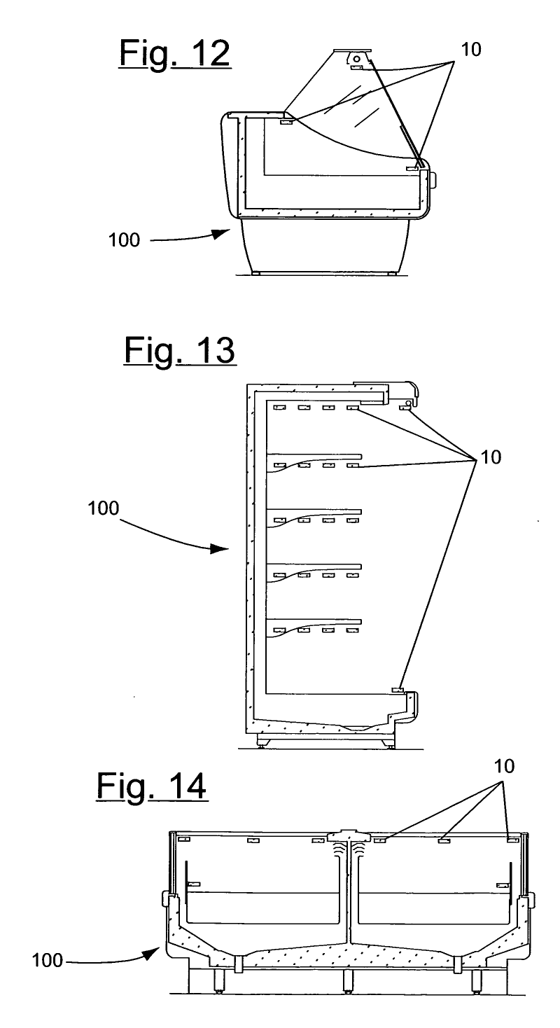

FIGS. 12-14 are schematic views of exhibition groups provided with lighting groups according to the present invention.

With reference to the figures, a lighting group is shown with 10 according to the present invention and with 100 an exhibition group is shown provided with such lighting group 10.

A first embodiment of such lighting group 10 is shown in FIG. 1 and comprises a multilayer structure 11, equipped with at least one conductive layer 12, 12′, 12″ that lies on specific elastic film interposed between two insulating layers 13, 13′, 13″, 13′″, and at least one lamp element 15, 15′, which can be selectively coupled and uncoupled as desired to the aforesaid multilayer structure 11 in any point of the same.

In particular, in the lighting group 10 according to the present invention, every conductive layer 12, 12′, 12″ is supplied with current from a related electric conductor 14, 14′, 14″ connected in turn to a current source, such as a common electrical socket.

Regarding the at least one lamp element 15, 15′, with such terms one refers to a generic light source such as an actual lamp, but also other embodiments of “LED” type that, as visible in FIGS. 2a and 2b, always have a upper portion 16, that is luminescent if crossed by current, that is extended outside the multilayer structure 11.

The at least one lamp element 15, 15′ moreover comprises a lower portion 17 that, when the lamp 15, 15′ is coupled with the multilayer structure 11, is nearly entirely extended inside the latter.

According to the invention, this lower portion 17, which as reported above is found inside the multilayer structure 11, comprises at least one electrically conductive zone 18, 18′, 18″ situated in a position such to be found, always when lamp 15, 15′ is coupled with the multilayer structure 11, in contact with the at least one conductive layer 12, 12′, 12″ which lies on specific elastic film.

In such a manner, once the lamp 15, 15′ is coupled to the multilayer structure 11, a transmission bridge is formed for the current from the at least one conductive layer 12, 12′, 12″, which as said lies on specific elastic film, to the upper portion 16, which is consequently “turned on”.

Naturally, regarding the above, the lamp 15, 15′ can therefore be “turned off” by simply extracting it from the related multilayer structure 11.

As said above, the at least one lamp element 15, 15′ can be selectively coupled and uncoupled, by perforation, to the aforesaid multilayer structure 11 in any point as desired. This is achieved due to the fact that the lower portion 17 is shaped to allow the perforation of the multilayer structure 11.

According to that set forth in FIG. 1, two possible different positions that can be assumed by the lamp 15 are shown with dashed lines, due merely to a manual movement of the lamp 15 itself shown in a continuous line.

In fact, as seen in FIGS. 2a and 2b, the lower portion 17 according to the invention comprises at least one thin cylindrical element 21 which is vertically extended below the upper portion 16; 21, in addition to being provided with at least one electrically conductive zone 18, 18′, 18″, comprises on its lower part a shaped perforation point of the multilayer structure 11.

According to a first embodiment shown in FIG. 2b, the lower portion 17 comprises a single thin cylindrical element 21 that is vertically extended below the upper portion 16 in which such thin cylindrical element 21 comprises a number of electrically conductive zones 18, 18′, 18″ equal to the number of conductive layers 12, 12′, 12″ and spaced so to come into contact with the related conductive layers 12, 12′, 12″ when lamp 15 is inserted by perforation in the multilayer structure 11.

According to another embodiment element shown in FIG. 2a, the lower portion 17 comprises a number of thin cylindrical elements 21 equal to the number of conductive layers 12, 12′, 12″.

In such case, the thin cylindrical elements 21 are placed next to each other, are vertically extended below the upper portion 16 and each comprise an electrically conductive zone 18, 18′, 18″ obtained at different positions, so to come into contact with a related conductive layer 12, 12′, 12″ when lamp 15 is inserted by perforation in the multilayer structure 11.

According to the invention, the multilayer structure 11 of the lighting group 10, which always comprises as is visible in FIGS. 3 and 4 at least one conductive layer 12, 12′, 12″ which lies on specific elastic film interposed between two insulating layers 13, 13′, 13″, 13′″, can advantageously be a support of flexible or rigid, and/or flat or cylindrical type.

According to a first preferential embodiment, the multilayer structure 11 can be, as shown in FIGS. 8 and 9, a rigid, flat support respectively comprising two or three conductive layers 12, 12′, 12″ which are flat, rigid and parallel to each other.

Naturally, in the above-reported embodiments, every conductive layer 12, 12′, 12″ is interposed between insulating layers 13, 13′, 13″, 13′″, in turn rigid and parallel.

Alternatively, according to another embodiment, the multilayer structure 11, as shown in FIGS. 5-7, can be a cylindrical and flexible support.

In such embodiment, the multilayer structure 11 comprises two flexible, cylindrical conductive layers 12, 12′, each of which coaxially interposed between two cylindrical insulating layers 13, 13′, 13″.

According to that just described, therefore, both the conductive layers 12, 12′ and the insulating layers 13, 13′, 13″ are concentric, so to make a cylindrical structure.

Finally, according to a final example shown in FIGS. 10-11, the multilayer structure 11 can be a flexible, flat support capable of assuming, for example, an “S” form as needed.

Also in such final case, the multilayer structure 11 can comprise two or three conductive layers 12, 12′ 12″ interposed between insulating layers 13, 13′, 13″, 13′″.

In particular, the lighting group 10 according to the present invention as described above is particularly advantageous if applied to an exhibition group 100.

In fact in such case, since the at least one lamp element 15, 15′ can be selectively coupled and uncoupled to the aforesaid multilayer structure 11 in any point as desired by perforation, due to the lower portion 17 shaped to allow the perforation of the multilayer structure 11, the lighting group 10 permits quickly modifying the lighting and/or colouring as desired, with which products housed in such exhibition groups 100 are highlighted.

In particular, the aforesaid exhibition groups 100 can be a refrigerated window, a refrigerated wall or refrigerated island, as shown respectively in FIGS. 12-14, but also a shelf or a common exhibition window. It is very easy to understand the functioning of the device, object of the finding.

The lighting group 10 according to the present invention comprises a multilayer structure 11, provided with at least one conductive layer 12, 12′, 12″, that lies on specific elastic film, interposed between insulating layers 13, 13′, 13″, 13′″ and selectively suppliable with current from an electric conductor 14, 14′, 14″, and at least one lamp element 15, 15′.

In particular, such at least one lamp element 15, 15′ can be selectively coupled by perforation in any point of said multilayer structure 11 and is provided with an upper portion 16 that is luminescent if crossed by current, and a lower portion 17 that is extended inside the multilayer structure 11 and provided with at least one electrically conductive transmission zone 18, 18′, 18″ for the current from the at least one conductive layer 12, 12′, 12″ to the upper portion 16.

Since the at least one lamp element 15, 15′ can be, as said, selectively coupled and uncoupled to the aforesaid multilayer structure 11 in any point as desired due to the lower portion 17 shaped to allow the perforation of the multilayer structure 11 itself, due to the present invention it is possible to modify the lighting and/or colouring emitted by the lighting group 10 as desired by merely manually moving the at least one lamp element 15, 15′ from one point to another.

It is clear, then, how the lighting group 10 of the present invention is particularly advantageous if used in exhibition groups 100, permitting the lighting of the products housed in the desired manner each time, without requiring any expense and/or substitution of components.

It has been seen that a lighting group, in particular for exhibition groups, and an exhibition group provided with such lighting group according to the present invention achieves the previously highlighted objects. The lighting group, in particular for exhibition groups, and the exhibition group provided with such lighting group of the present invention thus conceived is susceptible to numerous modifications and variations, all part of the same inventive concept; moreover, all details can be substituted with technically equivalent elements. In practice, the materials used, as well as their size, can be of any type according to technical needs.

1. Lighting group (10) comprising a multilayer structure (11), provided with at least one conductive layer (12, 12′, 12″) interposed between two insulating layers (13, 13′, 13″, 13′″) and selectively suppliable with current from a related electric conductor (14, 14′, 14″), and at least one lamp (15, 15′) that can be selectively coupled to said multilayer structure (11) in any point and provided with an upper portion (16) that is luminescent if crossed by current, that is extended outside said multilayer structure (11), and a lower portion (17) that is extended inside said multilayer structure (11), said lower portion (17) comprising at least one electrically conductive zone (18, 18′, 18″) in contact with said at least one conductive transmission layer (12, 12′, 12″) of the current from said at least one conductive layer (12, 12′, 12″) to said upper portion (16).

2. Lighting group (10) according to claim 1 characterised in that said lower portion (17) is shaped to allow the perforation of said multilayer structure (11).

3. Lighting group (10) according to claim 2 characterised in that said lower portion (17) comprises at least one thin cylindrical element (21) that is vertically extended below said upper portion (16), said at least one thin cylindrical element (21) being provided along the related development of said at least one electrically conductive zone (18, 18′, 18″) and at its lower part with a shaped point for perforating said multilayer structure (11).

4. Lighting group (10) according to claim 3 characterised in that said lower portion (17) comprises a single thin cylindrical element (21) that is vertically extended below said upper portion (16), said thin cylindrical element (21) comprising a number of said electrically conductive zones (18, 18′, 18″) equal to the number of said conductive layers (12, 12′, 12″).

5. Lighting group (10) according to claim 3 characterised in that said lower portion (17) comprises a number of thin cylindrical elements (21) equal to the number of said conductive layers (12, 12′, 12″), said thin cylindrical elements (21) being placed next to each other, vertically extended below said upper portion (16) and each comprising an electrically conductive zone (18, 18′, 18″) in different positions.

6. Lighting group (10) according to claim 1 characterised in that said multilayer structure (11) is a flexible support comprising at least one conductive layer (12, 12′, 12″) interposed between said insulating layers (13, 13′, 13″, 13′″).

7. Lighting group (10) according to claim 1 characterised in that said multilayer structure (11) is a rigid, flat support comprising at least one conductive layer (12, 12′, 12″) flat interposed between two flat insulating layers (13, 13′, 13″, 13′″) that are parallel to each other.

8. Lighting group (10) according to claim 7 characterised in that said multilayer structure (11) comprises two conductive layers (12, 12′, 12″), each of which interposed between two flat insulating layers (13, 13′, 13″, 13′″).

9. Lighting group (10) according to claim 1 characterised in that said multilayer structure (11) is a flexible cylindrical support comprising at least one cylindrical conductive layer (12, 12′, 12″) interposed between two concentric, cylindrical insulating layers (13, 13′, 13″, 13′″).

10. Lighting group (10) according to claim 9 characterised in that said multilayer structure (11) comprises two concentric, cylindrical conductive layers (12, 12′, 12″), each of which interposed between two cylindrical insulating layers (13, 13′, 13″, 13′″) that are concentric with respect to said two conductive layers (12, 12′, 12″).

11. Exhibition group (100) characterised in that it comprises at least one lighting group (10) according to claim 1.

12. Exhibition group (100) according to claim 11 characterised in that it is an exhibition window and/or a refrigerated exhibition window.

13. Exhibition group (100) according to claim 11 characterised in that it is a refrigerated wall.

14. Exhibition group (100) according to claim 11 characterised in that it is a refrigerated island.

15. Exhibition group (100) according to claim 11 characterised in that it is a shelf.
